(19) United States
(12) Patent Application Publication
(10) Pub. No.: US 2024/0311942 A1
(43) Pub. Date: Sep. 19, 2024

(54) MANAGEMENT OF SAFETY INVESTIGATIONS WITH AUTOMATICALLY GENERATED SUGGESTED ACTIONS

(71) Applicant: ServiceNow, Inc., Santa Clara, CA (US)

(72) Inventors: Jon Crane, San Diego, CA (US); Andre Hickey, Newbridge (IE); Séadna Smallwood, Tulla (IE); Eric Schroeder, San Diego, CA (US)

(21) Appl. No.: 18/123,119

(22) Filed: Mar. 17, 2023

(51) Int. Cl. G06Q 50/26; G06Q 10/10

(52) U.S. Cl. CPC G06Q 50/265; G06Q 10/103

(57) ABSTRACT

In the present application, a method and a system for managing a safety investigation of an incident are disclosed. A user interface for managing an investigation of an incident is provided, wherein the user interface includes content that is based on a role type of a user associated with the investigation. Information regarding the incident is received via the user interface. A suggested action is determined based on the information to address the incident. The user interface is updated to indicate the suggested action.

### BACKGROUND OF THE INVENTION

Companies often ensure that when a safety issue occurs, the root causes of the issue are identified, such that the root cause is addressed to prevent another safety issue. Safety investigation tools are point solutions that may be used to identify root causes. However, the safety investigation tools are disconnected from the rest of the enterprise, and thus utilizing these tools to conduct safety investigation across teams often includes performing manual processes. For example, a safety investigation may include manual communications or manual data collections, such as via emails, phone calls, and spreadsheets. Because of the manual processes caused by the disconnected point solutions, collaboration around important investigations across departments in the organization is challenging. Accordingly, the safety investigations are time consuming, laborious, and inefficient.

### BRIEF DESCRIPTION OF THE DRAWINGS

Various embodiments of the invention are disclosed in the following detailed description and the accompanying drawings.

FIG. 1 illustrates an exemplary process 100 for managing a safety investigation of an incident.

FIG. 2 illustrates another exemplary process 200 for managing a safety investigation of an incident.

FIG. 3 illustrates an exemplary safety investigation graphical user interface (GUI) of the safety investigation system, also referred to as the safety investigation workbench 300.

FIG. 4 illustrates an exemplary recommended next-steps section 400.

FIG. 5 illustrates an exemplary section 500 for logging a sequence of events of the incident.

FIG. 6 illustrates an exemplary section 600 for adding the people involved in the safety investigation.

FIG. 7 illustrates an exemplary section 700 for logging the findings of the safety investigation.

FIG. 8 illustrates an exemplary root cause analysis section 800.

FIG. 9 illustrates an exemplary root cause analysis (RCA) wizard 900.

FIG. 10 illustrates an exemplary suggested actions section 1000.

FIG. 11 illustrates another exemplary safety investigation workbench 1100.

FIG. 12 illustrates an exemplary five whys root cause analysis wizard 1200.

FIG. 13 illustrates an exemplary user interface 1300 for monitoring and tracking the progress of the assigned corrective and preventative actions of an incident.

FIG. 14 illustrates an exemplary assigned action record 1400.

FIG. 15 illustrates an example of creating an action entry corresponding to an incident during the root cause analysis.

FIG. 16 illustrates an example of creating an action entry corresponding to an incident from the safety investigation workbench 1600.

FIG. 17 illustrates an example of creating an action entry corresponding to an incident from the Health and Safety Actions tab on an investigation record 1700.

FIG. 18 illustrates an example of creating the content of an action entry 1800.

FIG. 19 illustrates an example of accessing the assigned actions as a non-safety team member user.

FIG. 20 illustrates an example of a to-do list including the actions assigned to a non-safety user 2000.

FIG. 21 illustrates an exemplary playbook 2100 for designing a workflow using Process Automation Designer.

FIG. 22 illustrates another exemplary playbook 2200.

FIG. 23 illustrates how a workflow is displayed as a playbook 2300 on a safety incident 2300.

FIG. 24 illustrates how a workflow is displayed as a playbook 2400 on a safety investigation 2400.

FIG. 25 is a functional diagram illustrating a programmed computer system for executing some of the processes herein in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

In the present application, a method and a system for managing a safety investigation of an incident are disclosed. A user interface for managing an investigation of an incident is provided, wherein the user interface includes content that is based on a role type of a user associated with the investigation. Information regarding the incident is received via the user interface. A suggested action is determined based on the information to address the incident. The user interface is updated to indicate the suggested action.

A safety management system enables one or more safety teams to conduct thorough investigations, discover root causes of corresponding safety issues, and assign actions. The improved system has many benefits. The system includes easy-to-use interfaces for managing investigations, recording findings and observations, and tracking remediation status, thereby reducing the time for conducting the safety investigations. The system allows streamlined collaboration such that investigation teams can collaborate with peers across departments. The system provides intelligent suggestions that guide the safety investigators into the next best action to take. The system provides a single interface for tracking and referencing all artifacts for an investigation so that root causes can be more effectively determined. The suggested corrective actions save time and remove guesswork. Reduction in safety incidents by the safety system results in a safer workplace.

The improved system has many features. It includes a single, easy-to-use interface for managing investigations. Collaborators may be easily added to an investigation. The system provides artificial intelligence (AI) based recommended next-steps in response to different incidents. The system includes a root cause analysis (RCA) wizard with expandable RCA methods. The system provides suggested corrective and preventative actions (CAPAs) driven by AI. It provides AI-based collaboration suggestions. Using the system, safety investigation collaboration is simplified and streamlined, and the process of conducting an investigation is guided intelligently by machine learning.

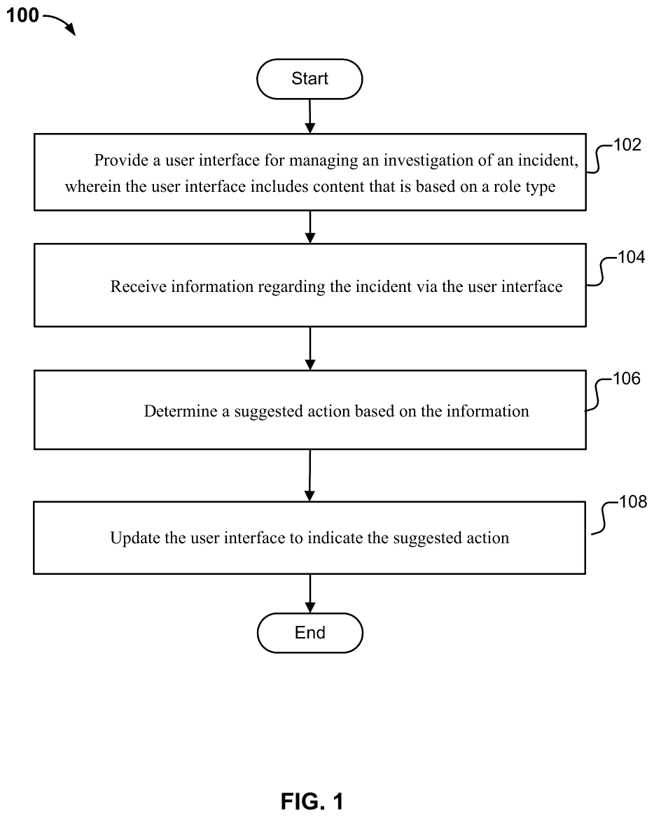

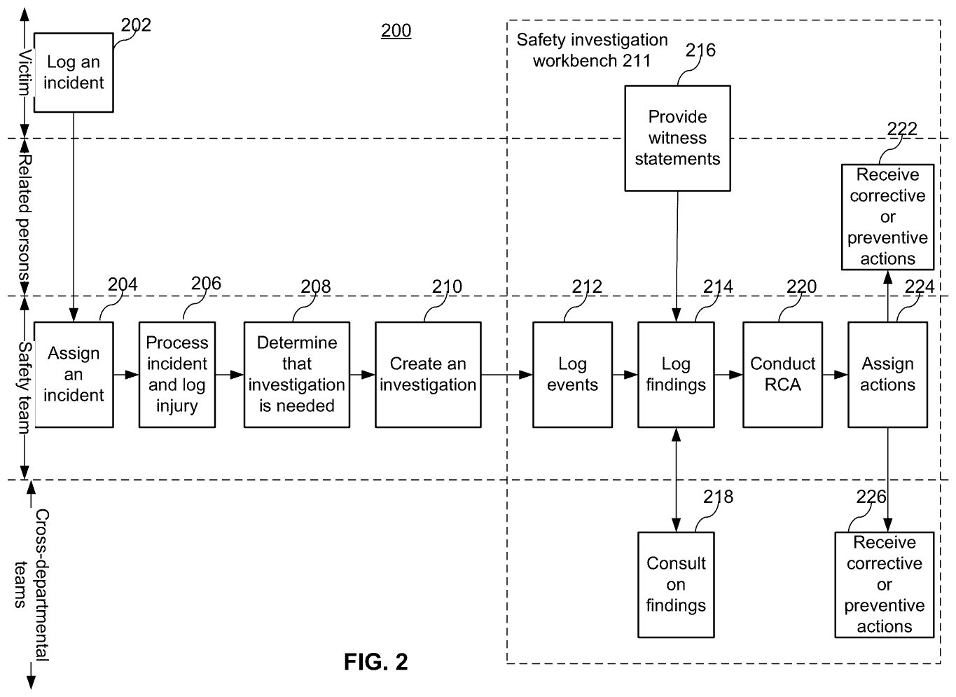

FIG. 1 illustrates an exemplary process 100 for managing a safety investigation of an incident. FIG. 2 illustrates another exemplary process 200 for managing a safety investigation of an incident.

With reference to FIG. 1, at 102 of process 100, a user interface for managing an investigation of an incident is provided, wherein the user interface includes content that is based on a role type of a user associated with the investigation. At 104 of process 100, information regarding the incident is received via the user interface.

In some embodiments, the role types include the victim of the incident, persons who have not suffered any injuries but are relevant or related to the incident, safety investigation team members who are responsible for the safety investigations, and cross-departmental team members who may receive instructions or suggestions from the safety investigations. For example, in a slip-and-fall injury in which a person slipped on the premise of another and, as a result, suffered injury, the person suffering injury is the victim. The persons who have not suffered any injuries but are relevant or related to the incident may include bystanders who were in the vicinity of the incident to be witnesses to the incident. Bystanders may include the persons who offered help to the victim or persons who witnessed the incident. For example, bystanders may include an employee, a manager, or a customer at the incident. A safety investigation team member is a safety investigator who is using the safety investigation system to manage the safety investigation of the incident. A cross-departmental team member is a person who may receive instructions or suggestions from the safety investigations. For example, if the slip-and-fall injury is found to be caused by a water leak from a pipe, then a cross-departmental team member may be an employee or a manager in the maintenance department. Other cross-departmental team members may include an employee or a manager in the janitorial department. Other cross-departmental team members may include a building or facilities manager.

With reference to FIG. 2, different steps may be performed by different users with different role types. The user interface may be customized based on the role types with respect to the investigation. Different information is collected from different users with different role types via the customized user interface.

At 202, the user interface may be provided to the victim for logging an incident after a safety issue had occurred. The customized user interface for a victim may be used to collect information regarding the incident, including the details of the incident, the injuries, income losses, medical treatment and costs, any other losses, environmental conditions (e.g., slippery floor, inadequate lighting, noise, etc.), and the like.

The user interface may be customized for a safety investigation team member. At 204, the incident is assigned to a safety team member. For example, the assignment may be based on a safety investigation team member's availability and areas of expertise. At 206, the incident is processed by the assigned safety investigation team member. Any injuries are logged by the safety investigation team member via the user interface. At 208, a determination is made that a safety investigation is needed. At 210, a safety investigation is launched and the safety investigation case is created in the safety investigation workbench 211. At 212, the sequence of events leading up to the issue is logged into the system via the user interface customized for a safety investigation team member.

The user interface may be customized and provided to the victim or the persons who have not suffered any injuries but are relevant or related to the incident. At 216, any findings observed during the investigation, including victim's statements or witness statements, may be collected from the victim or the persons who are relevant or related to the incident, respectively. For example, the safety investigation team member may assign a task to a witness to provide the witness's statements via the interface and monitor the status of the assigned task.

At 214, the findings received from the victim or the witnesses may be logged into the system. At 218, cross-departmental team members may be consulted on the findings. For example, the safety investigation team member may assign a task to the cross-departmental team members to analyze the findings or provide consultation regarding the findings and monitor the status of the assigned task. The user interface may provide AI-generated recommended next-steps for guiding a safety investigation team member along in the investigation. At 220, a root cause analysis (RCA) may be conducted by an investigation team member or group of team members as a collaborative effort. For example, the RCA may be performed based on a five whys method, as will be described further below.

Referring back to process 100 of FIG. 1, at 106, a suggested action is determined based on the information to address the incident. In some embodiments, the suggested action is determined based on the received information and a trained machine learning model. At 224 in process 200, actions are suggested based on the root cause identified. Based on the root cause and the findings, additional actions to take are suggested by the system. New actions may be opened manually by the safety investigator. Two types of actions may be assigned: corrective and preventative.

At 108, the user interface is updated to indicate the suggested action. The actions may be assigned across the organization to remediate the root causes of the issue and the status of the assigned actions may be monitored. For example, as shown in FIG. 2, corrective or preventative actions may be provided to the persons who have not suffered any injuries but are relevant or related to the incident at step 222 and to the cross-departmental team members at step 226. Examples of corrective actions may include cleaning up an oil spill that caused the slip-and-fall incident and repairing the broken heating, ventilation, and air conditioning (HVAC) system for cooling the shop floor. Examples of preventative actions may include assigning “Working at Height” training to all employees and conducting routine inspections on all warehouse equipment. After the actions are completed, the safety investigation may be closed.

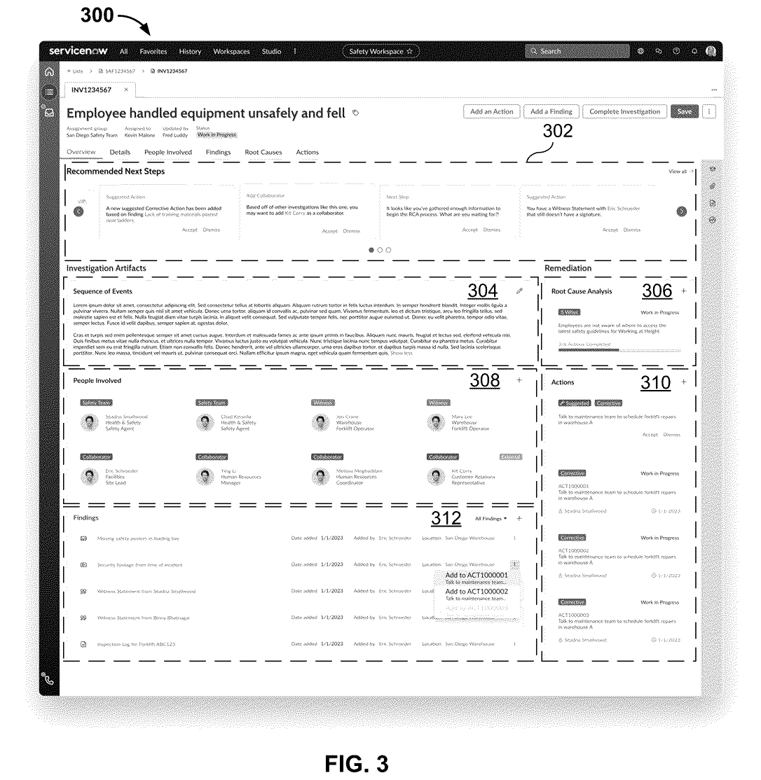

FIG. 3 illustrates an exemplary safety investigation graphical user interface (GUI) of the safety investigation system, also referred to as the safety investigation workbench 300. Safety investigation workbench 300 includes multiple sections, each for handling a different feature, including a recommended next-steps section 302, a section 304 for logging a sequence of events of the incident, a root cause analysis section 306, a section 308 for adding the people involved in the safety investigation, a suggested actions section 310, and a findings section 312. In this example, the incident involves an employee who handled equipment (e.g., a ladder) unsafely and fell.

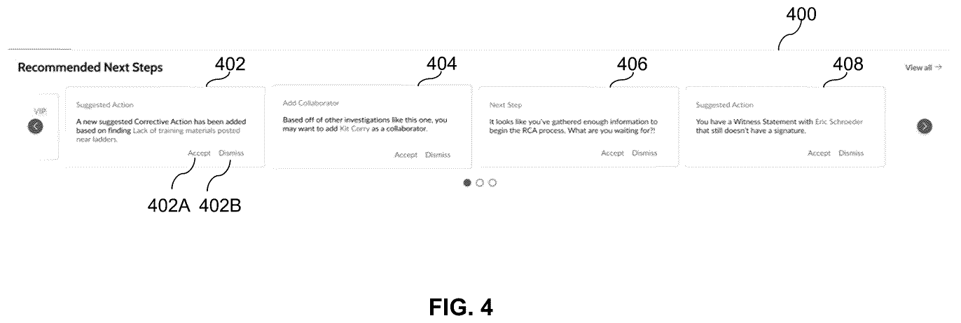

FIG. 4 illustrates an exemplary recommended next-steps section 400. Different information is provided to a trained machine learning model to automatically determine one or more suggested next steps for the investigation of the incident, including a suggested next best step for the investigator to take when the safety investigator is conducting the investigation or a suggested corrective or preventative action for the investigator to accept. In some embodiments, suggested next steps are learned from steps that were previously taken in similar safety investigations. For example, if the system has detected many investigations for slip-and-fall issues, and those incidents typically follow a similar workflow (with similar or same collaborators, or with similar or same root cause analysis), then these steps may be displayed to the safety investigator in recommended next-steps section 400 for them to accept them or decline them as next steps. The suggested next steps help the safety investigator with fast-tracking their investigation process and choosing the right steps to take when conducting the safety investigations. In some embodiments, a trained machine learning model is used to determine a suggested next step for conducting the investigation of the incident via the user interface, wherein the trained machine learning model is trained based on past steps for conducting past investigations of incidents that are similar to the incident.

The suggested next steps for the safety investigator to select from may include suggested corrective or preventative actions that may be provided to the persons who have not suffered any injuries but are relevant or related to the incident at step 222 and to the cross-departmental team members at step 226. The suggested action may be determined by a trained machine learning model that is trained based on historical data and similar investigations. For example, a suggested next step 402 is a suggested corrective action that is added based on findings. The suggested corrective action is to post training materials near equipment, such as ladders. Suggested next step 402 includes an icon 402A for the safety investigator to accept it as a corrective action and also an icon 402B for the safety investigator to dismiss it as a corrective action. After the action is accepted, the action may be assigned to the appropriate user.

The suggested next steps for the safety investigator to select from may include adding an individual as a collaborator. For example, a suggested next step 404 is to add an individual as a collaborator (or referred to as one of the persons involved) based on historical data or other past safety investigations that are similar to the current investigation. In some embodiments, a suggested new user to be added as a user with a role type as a collaborator may be determined based on a trained machine learning model, wherein the trained machine learning model is trained based on past users involved in past investigations of past incidents that are similar to the incident.

The suggested next steps for the safety investigator to select from may include a suggested next step for the investigator to take when the safety investigator is conducting the investigation. The suggested next step may be determined based on how previous investigations have played out in addition to the current status of the active investigation. Examples include following up on a witness statement or communicating with the team. For example, a suggested next step 406 is to begin the RCA process as the system has determined that sufficient information has been gathered for the current investigation. In yet another example, a suggested next step 408 is to remind the safety investigator to follow up with a witness statement that is missing a witness's signature.

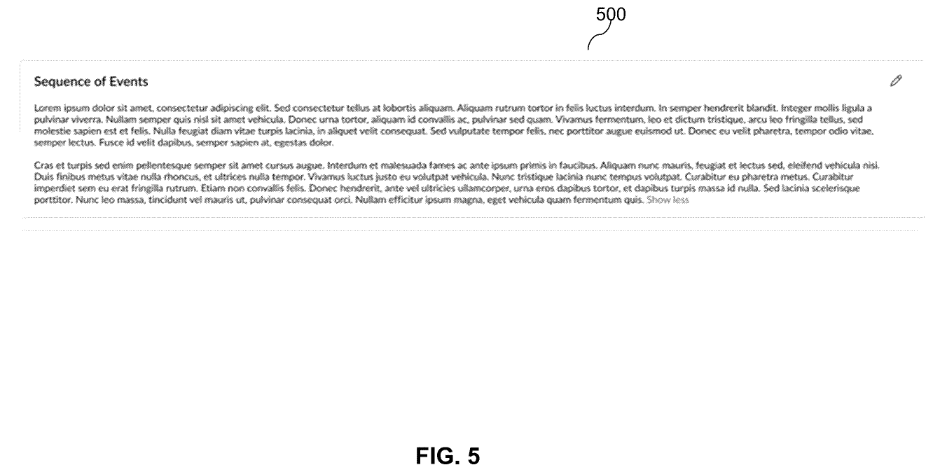

FIG. 5 illustrates an exemplary section 500 for logging a sequence of events of the incident. Section 500 may include a detailed log of everything that occurred leading up to the investigation. For example, the sequence of events may include the time and location of the incident, the time when the victim was being helped by another employee, and the time when the equipment was installed or inspected, etc. Section 500 may be used at step 212 of process 200 in FIG. 2.

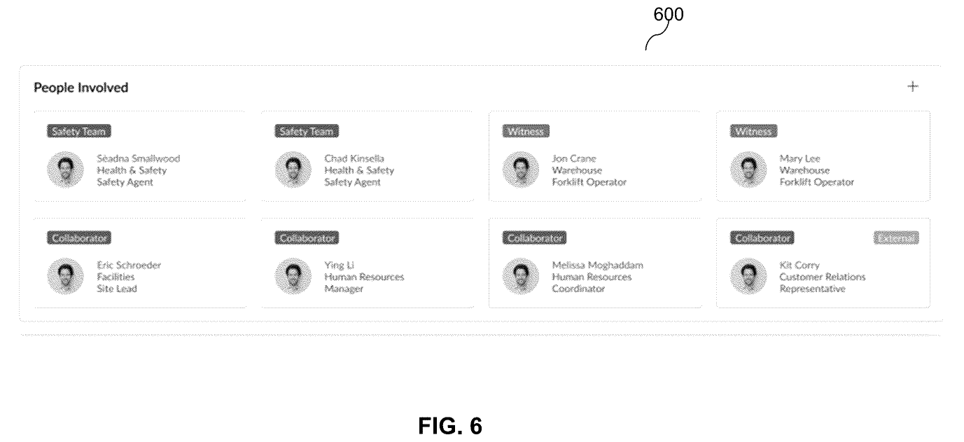

FIG. 6 illustrates an exemplary section 600 for adding the people involved in the safety investigation. The people involved in the safety investigation may include any safety investigation team members, related persons, witnesses, and collaborators. Collaborators of the safety investigation include cross-departmental team members who may receive instructions or suggestions from the safety investigation. Collaborators from all across the organization, or even third-party collaborators may be added. Section 600 allows the investigators to easily document anyone that they have worked with throughout the course of the investigation and the roles of the collaborators. Collaborators may be members of different departments, including the human resource department, legal department, customer relations departments, or third-party vendors. For example, collaborators may include a site lead of the facilities department, a human resources manager, a human resources coordinator, or a customer relations representative.

In some embodiments, a trained machine learning model may be used to suggest collaborators to be added to section 600 based on previous investigations. For example, if past investigations at the San Diego office always include John Smith as a collaborator, then the system may suggest to the safety investigator via the user interface to add John as a collaborator for the current investigation.

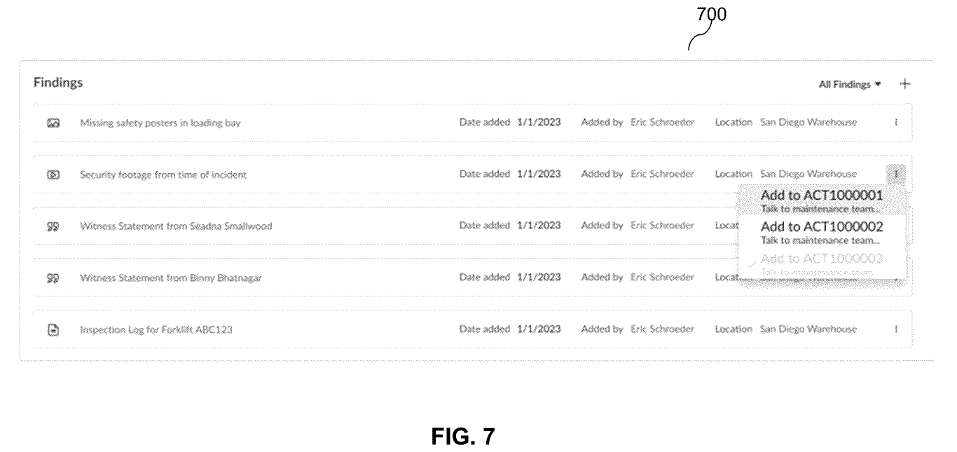

FIG. 7 illustrates an exemplary section 700 for logging the findings of the safety investigation. Section 700 may be used to log anything discovered throughout the course of the investigation that may be relevant to identifying the root causes. The contents of the findings may be assigned by the safety investigator to any corresponding suggested actions to provide additional context for the suggested corrective or preventative actions assigned to the collaborators. For example, if a corrective action is assigned to the safety investigation team to post safety signs next to equipment, then the investigator may attach an image of the equipment without a safety sign for providing added context. Section 700 may be used at step 214 of process 200 in FIG. 2.

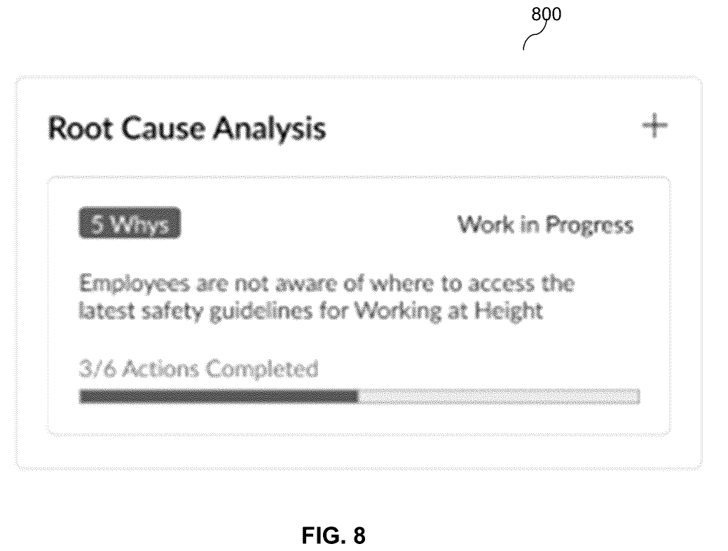

FIG. 8 illustrates an exemplary root cause analysis section 800. In some embodiments, the information gathered through the investigation may be used by the investigators to conduct a root cause analysis (RCA). For example, as shown in section 800, the root cause identified in the slip-and-fall incident is due to the employees not being aware of where to access the latest safety guidelines for working at height. Safety investigation workbench 211 allows investigators to work with teammates across the globe as they work through the appropriate root cause analysis method. Safety investigation workbench 211 further includes a root cause analysis wizard that may guide investigators into building an RCA team and choosing the right method.

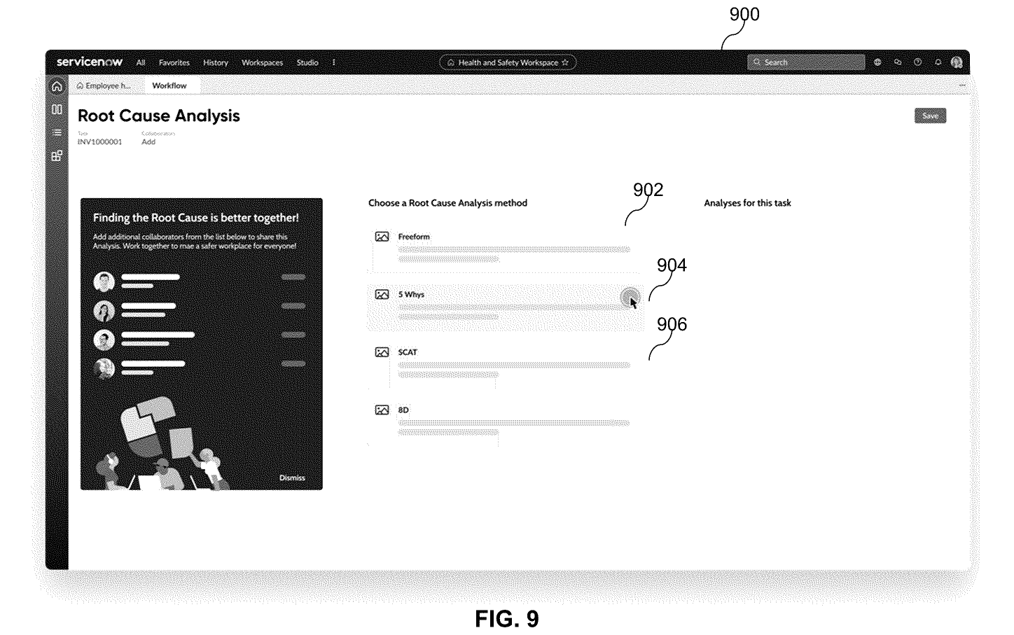

FIG. 9 illustrates an exemplary root cause analysis (RCA) wizard 900. RCA wizard 900 is a user interface that leads the investigator through a sequence of steps to determine the root cause of an incident. Different root cause analysis methods may be selected from RCA wizard 900, including a freeform method 902, a five whys method 904, and a systematic cause analysis technique (SCAT) 906.

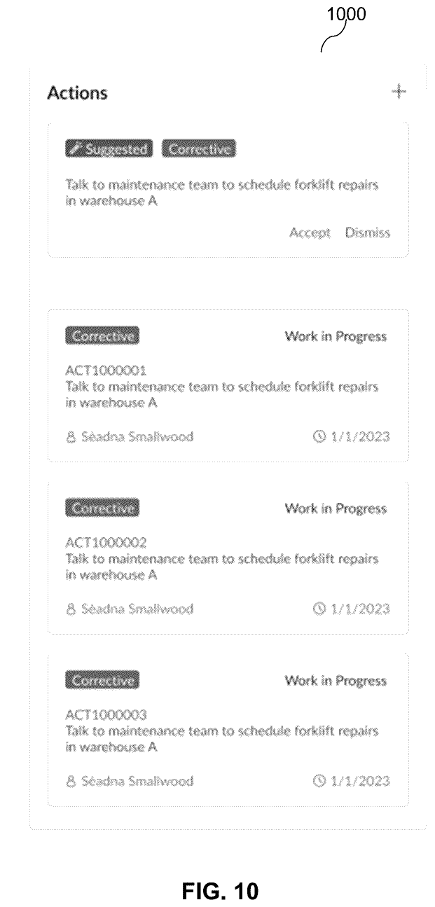

FIG. 10 illustrates an exemplary suggested actions section 1000. Actions are assigned to perform corrective or preventative activities. Corrective activities correct current issues, and preventative activities are designed to prevent specific events or behaviors from happening again. For example, as shown in FIG. 10, a corrective action includes discussing with the maintenance team to schedule forklift repairs in a warehouse.

In some embodiments, a trained machine learning model may be used to provide on section 1000 of safety investigation workbench 300 the suggested actions for the investigator to assign. For example, if several previous chemical burn investigations have resulted in actions assigned to the safety team to train the staff on when and how to use personal protective equipment (PPE) when handling chemicals, then the trained machine learning model may provide the same suggested action automatically. Section 1000 helps the investigator to select the right actions for the investigation.

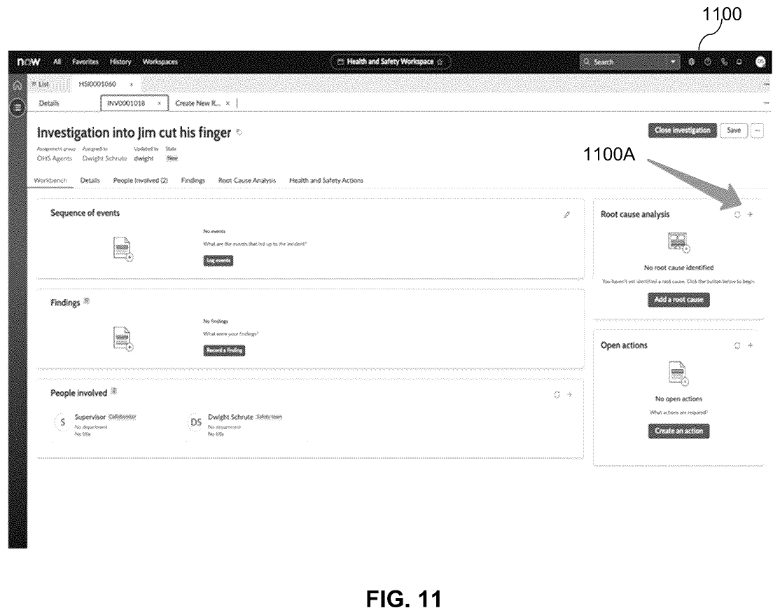

One of the root cause analysis methods is the five whys root cause analysis method. Five whys (or 5 whys) method is an iterative interrogative technique used to explore the cause-and-effect relationships underlying a particular problem. The primary goal of the technique is to determine the root cause of a defect or problem by repeating the question “Why?” five times. The answer to the fifth why should reveal the root cause of the problem. The five whys root cause analysis method is initiated from the safety investigation workbench. FIG. 11 illustrates another exemplary safety investigation workbench 1100. This example shows how a safety investigator adds a new root cause to an empty investigation. The five whys root cause analysis method is initiated by clicking on the “+” button 1100A on safety investigation workbench 1100.

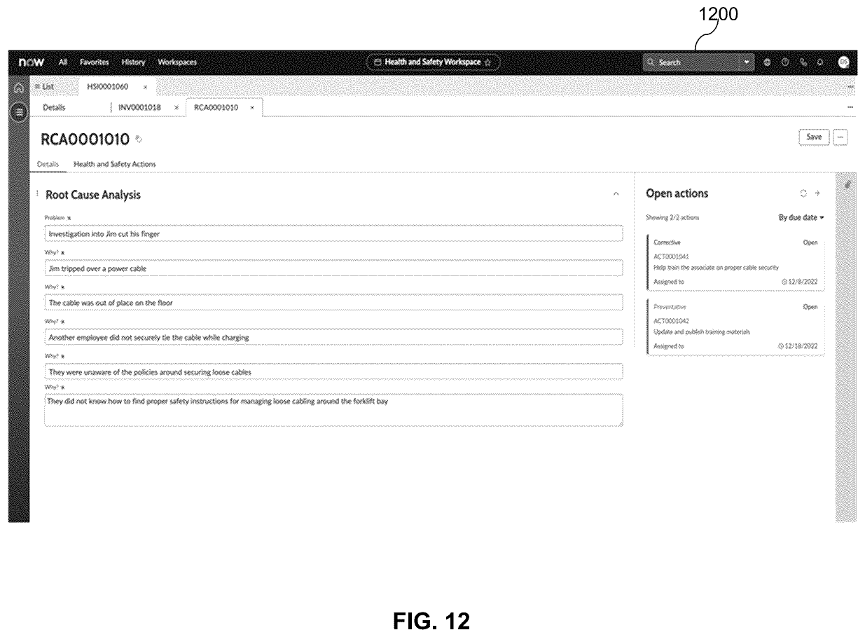

FIG. 12 illustrates an exemplary five whys root cause analysis wizard 1200. Five whys root cause analysis wizard 1200 includes five entries for entering the answers to the five whys or the five causes of the incident. Any of the safety investigation team members in the safety team may enter one or more five whys answers. When topics come up during the root cause analysis that need immediate attention, actions may be assigned by the safety member. As shown in five whys root cause analysis wizard 1200, the incident is related to an employee suffering from a cut of his finger. Five entries were entered as the answers to the five “whys.” First, the employee tripped over a power cable. Second, the power cable was out of place and lying on the floor. Third, another employee did not securely tie the cable while charging it. Fourth, the employees were unaware of the policies about securing loose cables. Fifth, the employees did not know how to find the proper safety instructions for managing loose cables around the forklift bay.

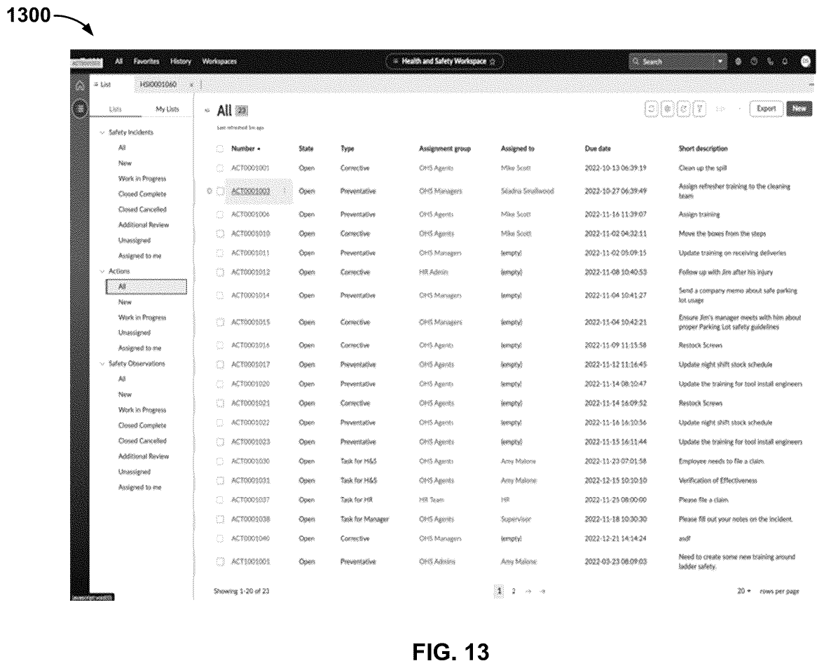

FIG. 13 illustrates an exemplary user interface 1300 for monitoring and tracking the progress of the assigned corrective and preventative actions of an incident. A list of assigned actions are accessible by the safety team members or management via interface 1300. Each listed action may include an identifier or unique number, the status, the type of action, the department or group that the action is assigned to, the person that the action is assigned to, the due date of the assigned action, and a short description of the assigned action.

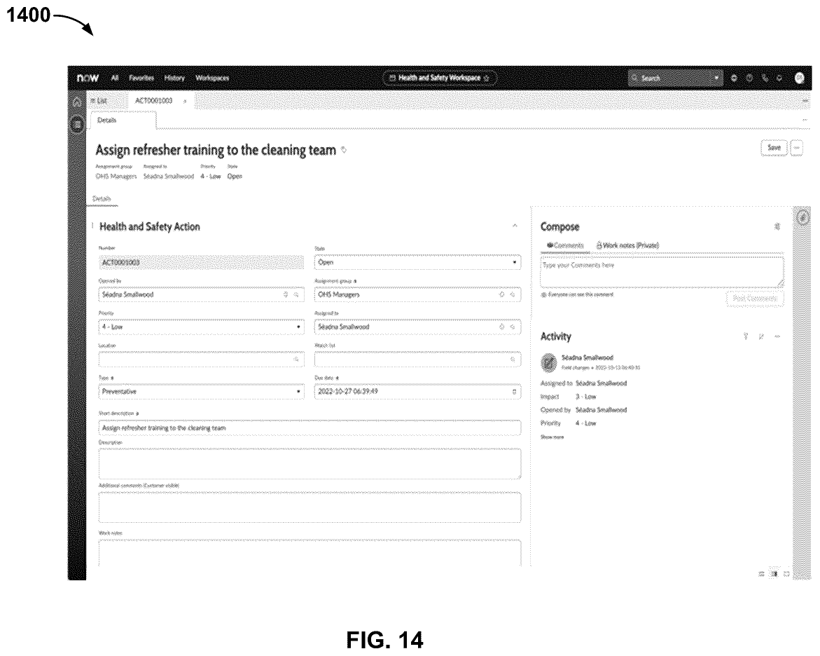

FIG. 14 illustrates an exemplary assigned action record 1400. The assigned action record 1400 is opened when an entry in the list of assigned actions on user interface 1300 is clicked. The assigned action record 1400 may be used by the safety members or staff to enter updates and track the status of the action from the beginning to its resolution.

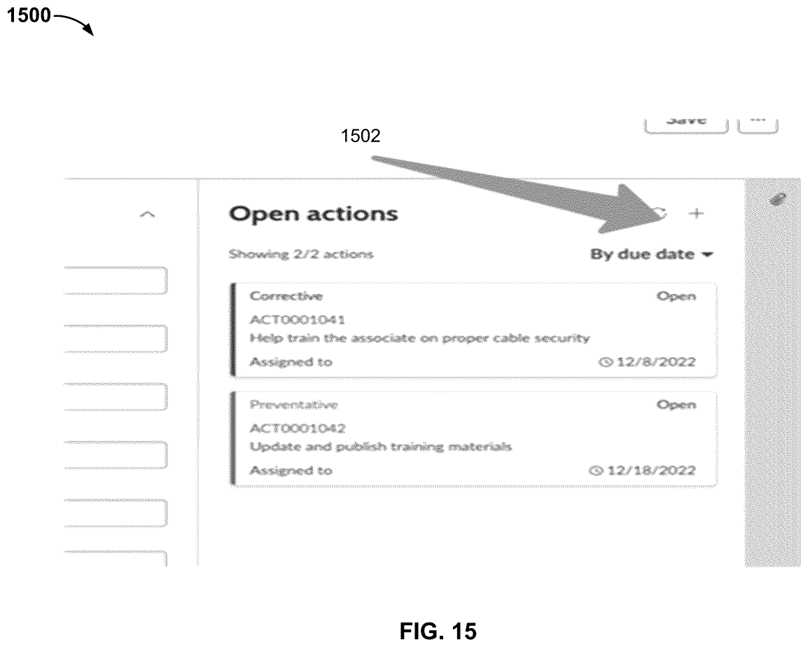

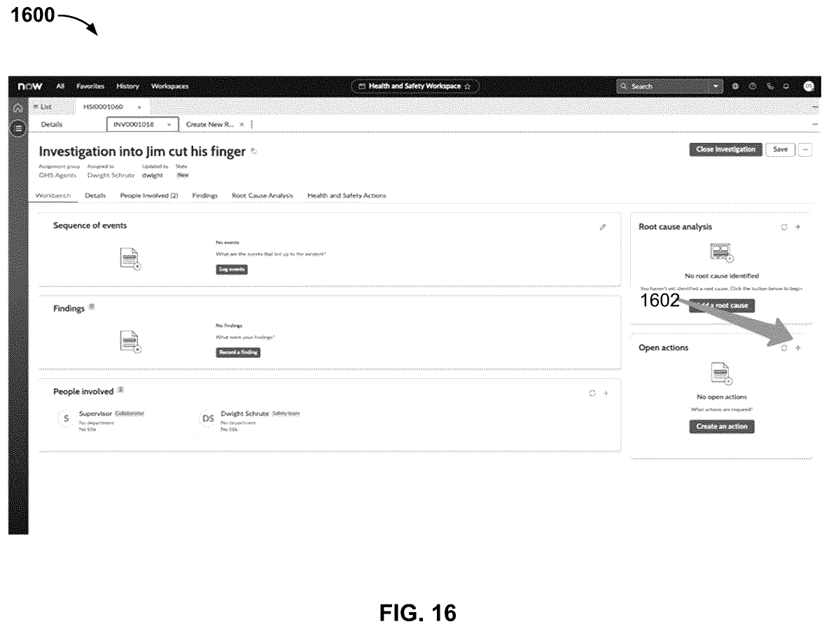

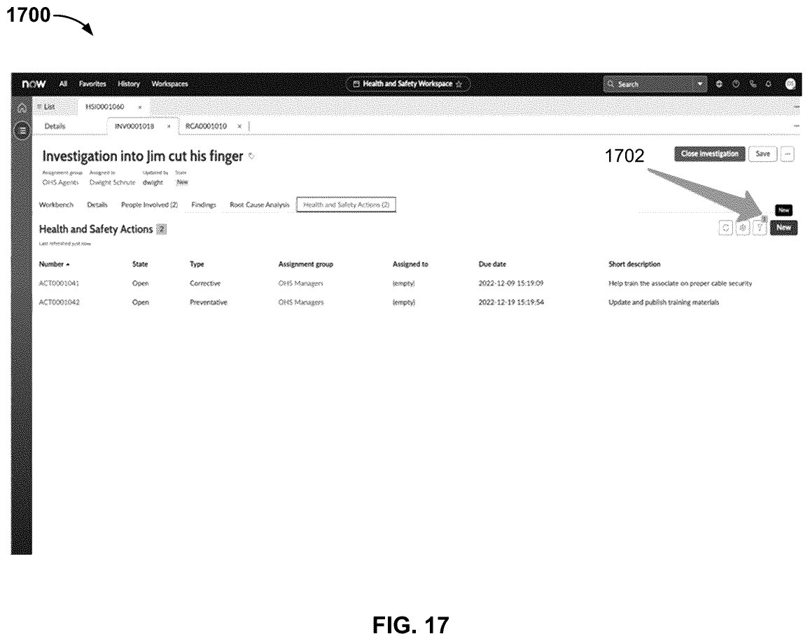

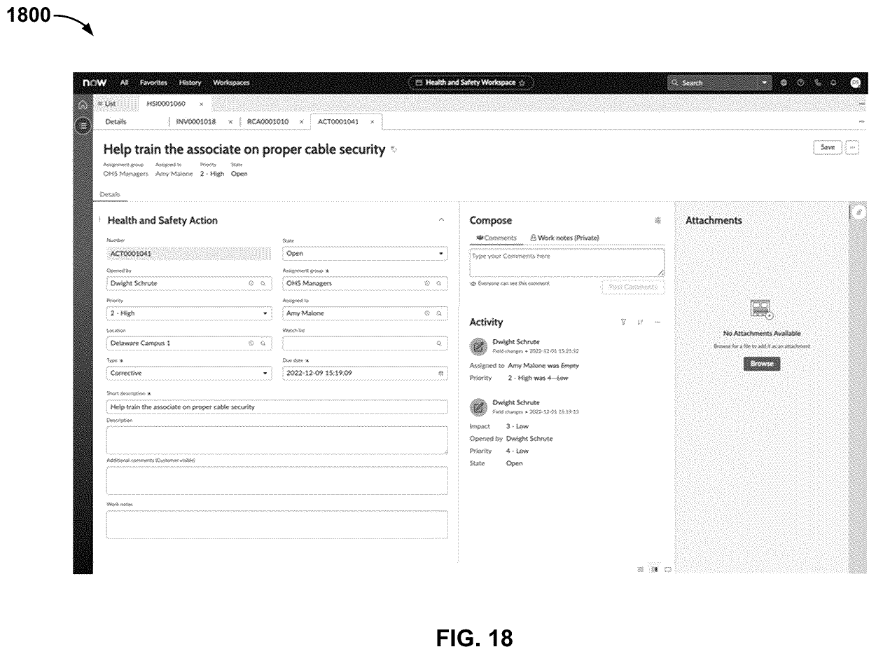

There are three ways to initiate the creation of an action entry. FIG. 15 illustrates an example of creating an action entry corresponding to an incident during the root cause analysis. An action entry corresponding to an incident may be created while performing the root cause analysis by clicking on the “+” button 1502 on the root cause analysis wizard 1500. FIG. 16 illustrates an example of creating an action entry corresponding to an incident from the safety investigation workbench 1600. An action entry corresponding to an incident may be created by clicking on the “+” button 1602 on safety investigation workbench 1600. FIG. 17 illustrates an example of creating an action entry corresponding to an incident from the Health and Safety Actions tab on an investigation record 1700. An action entry corresponding to an incident may be created by clicking on the “New” button 1702. FIG. 18 illustrates an example of creating the content of an action entry 1800. Action entry 1800 is a form including a number of fields that may be entered by a safety team member. Some of the fields are required fields and some of the fields are optional.

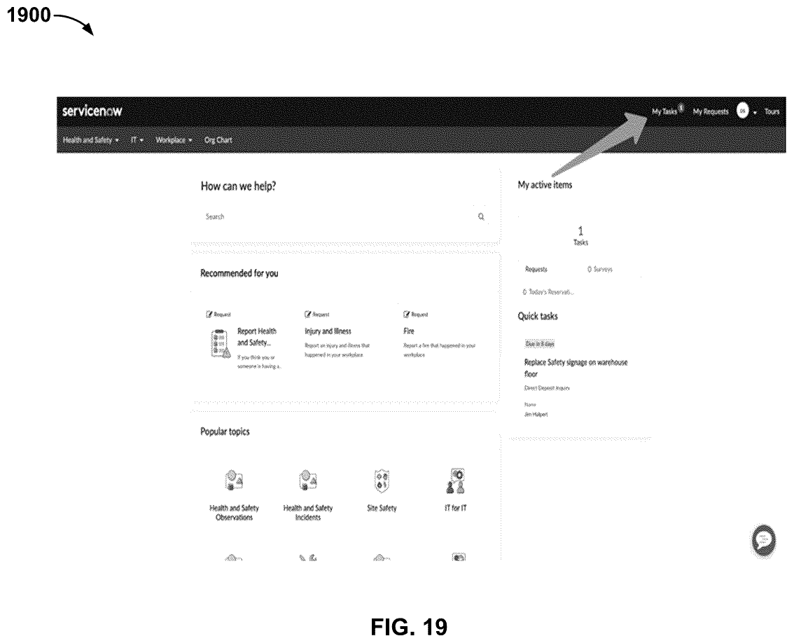

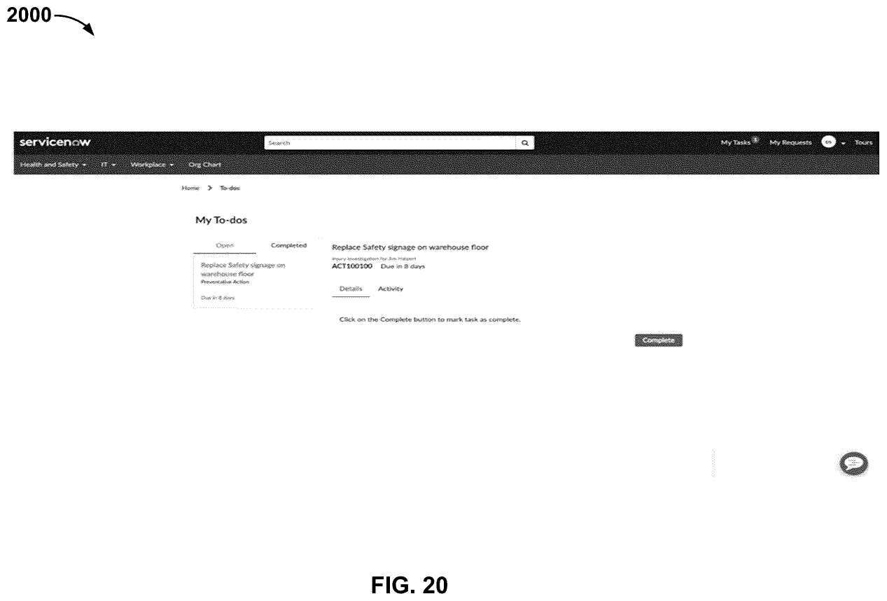

FIG. 19 illustrates an example of accessing the assigned actions as a non-safety team member user. Employees who are not a safety team member can log into an employee center portal 1900 and see their actions as tasks/to-dos from the portal. Clicking into “My Tasks” shows the active to-dos of the employee. FIG. 20 illustrates an example of a to-do list including the actions assigned to a non-safety user 2000. In this example, a to-do is a preventative action assigned to the current user. The preventative action is to replace the safety signage on the warehouse floor.

A playbook feature may be used to drive records through to completion. The playbook feature defines one or more workflows aimed at ensuring a consistent response to different situations commonly encountered. For example, a playbook may give the investigator a step by step view of actions or tasks that may be performed. A workflow may specify multiple actions taken by multiple individuals in a particular order. An action may be a part of a defined workflow, wherein a workflow defines one or more actions in a predetermined order and one or more users associated with the one or more actions. For example, the workflow may specify multiple actions in a particular order, wherein each action is performed by different members in different departments. A complex action may be divided into simpler actions and the complex action may be defined by a workflow including the simpler actions.

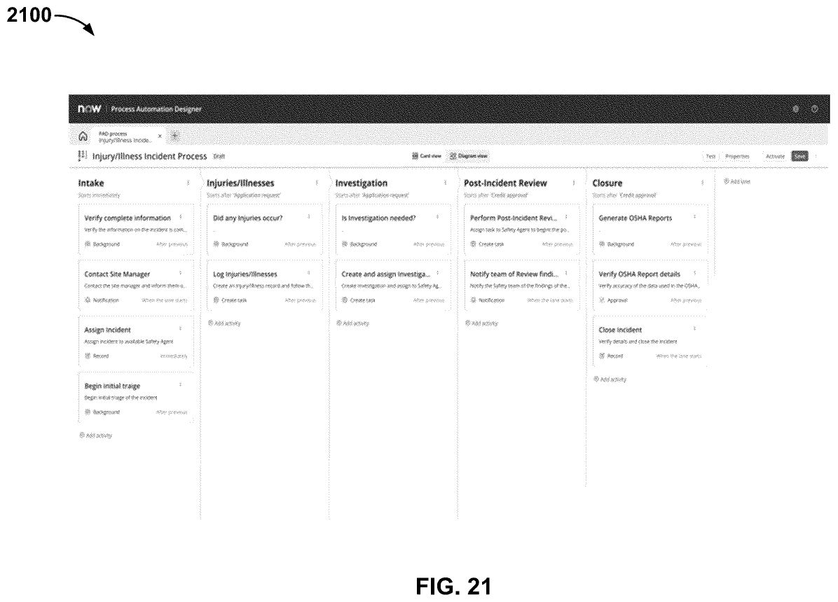

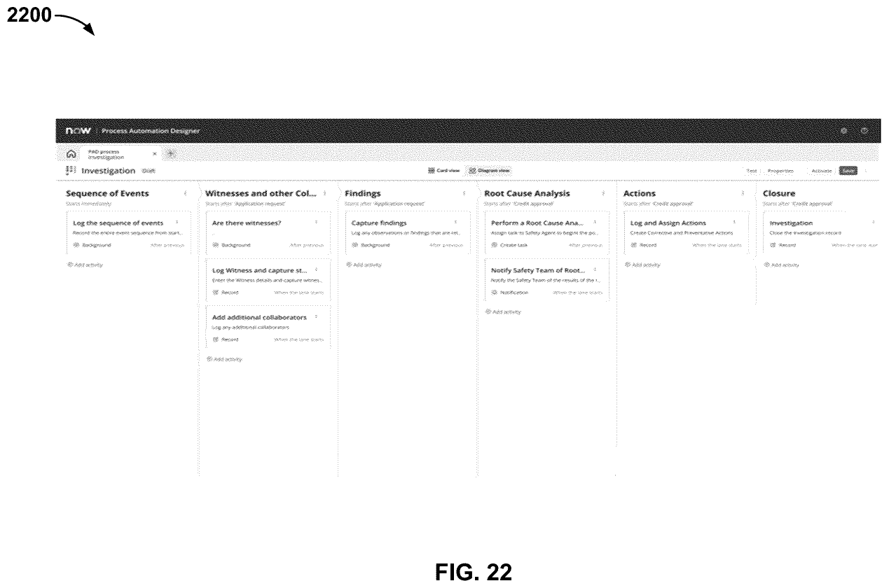

FIG. 21 illustrates an exemplary playbook 2100 for designing a workflow using Process Automation Designer. The workflow includes an intake process, which includes the steps for the safety investigator to follow for reviewing and accepting new projects or work requests. The intake process may be performed at step 204 of process 200 in FIG. 2. The workflow includes the logging of the injuries or illnesses, which may be performed at step 206 of process 200 in FIG. 2. The workflow includes determining whether an investigation is needed and then creating the investigation, which may be performed at step 208 and step 210 of process 200. The workflow includes a post-accident review process, which may be performed by safety investigation workbench 211. The workflow further includes a process for closing the incident. FIG. 22 illustrates another exemplary playbook 2200.

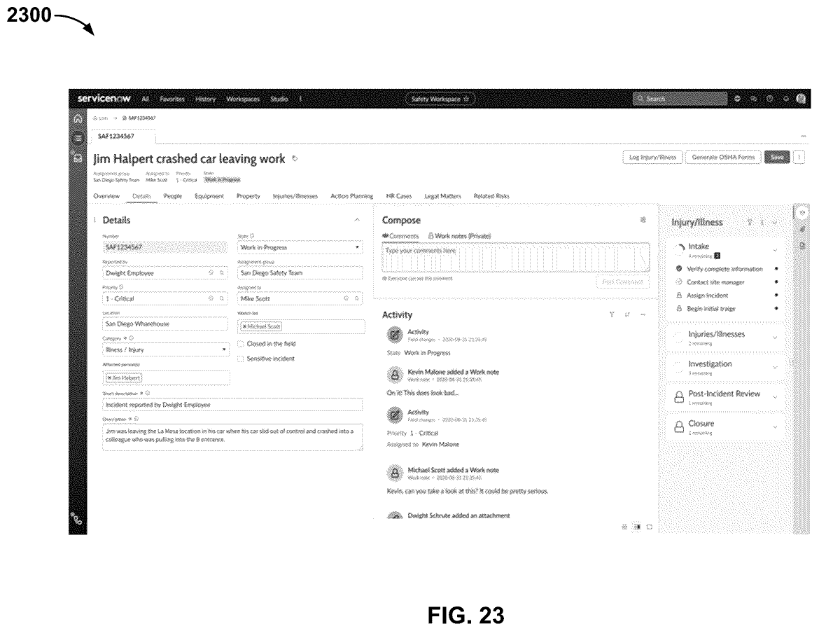

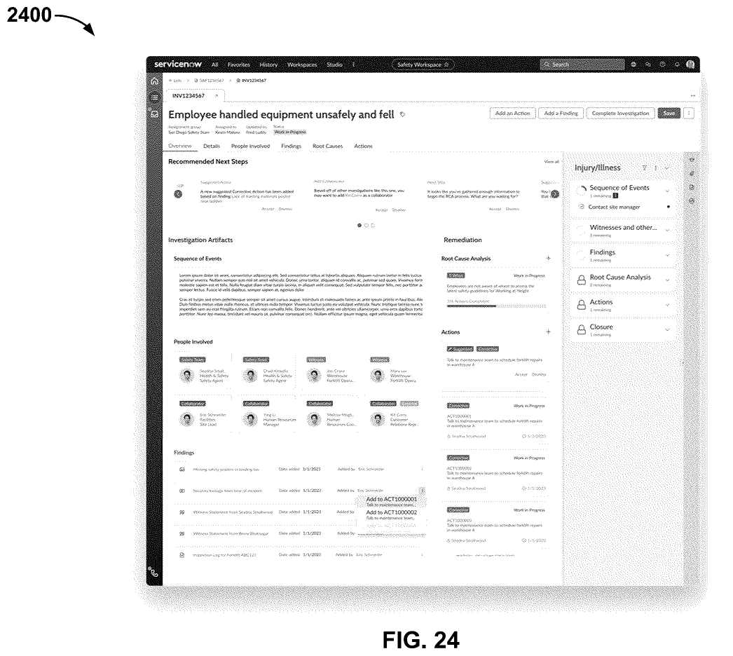

FIG. 23 illustrates how a workflow is displayed as a playbook 2300 on a safety incident 2300. The workflow is presented on the incident form as a playbook. FIG. 24 illustrates how a workflow is displayed as a playbook 2400 on a safety investigation 2400. The workflow is presented on the investigation workbench as a playbook.

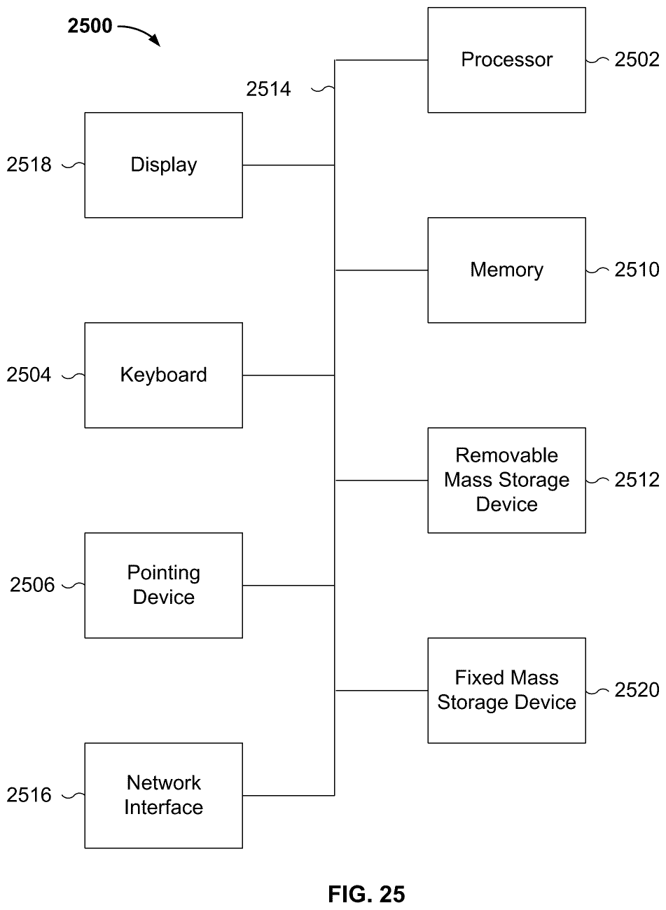

FIG. 25 is a functional diagram illustrating a programmed computer system for executing some of the processes herein in accordance with some embodiments. As will be apparent, other computer system architectures and configurations can be used as well. Computer system 2500, which includes various subsystems as described below, includes at least one microprocessor subsystem (also referred to as a processor or a central processing unit (CPU)) 2502. For example, processor 2502 can be implemented by a single-chip processor or by multiple processors. In some embodiments, processor 2502 is a general purpose digital processor that controls the operation of the computer system 2500. Using instructions retrieved from memory 2510, the processor 2502 controls the reception and manipulation of input data, and the output and display of data on output devices (e.g., display 2518). In some embodiments, processor 2502 includes and/or is used to execute/perform process 100 and process 200 described above with respect to FIG. 1 and FIG. 2, respectively.

Processor 2502 is coupled bi-directionally with memory 2510, which can include a first primary storage, typically a random access memory (RAM), and a second primary storage area, typically a read-only memory (ROM). As is well known in the art, primary storage can be used as a general storage area and as scratch-pad memory, and can also be used to store input data and processed data. Primary storage can also store programming instructions and data, in the form of data objects and text objects, in addition to other data and instructions for processes operating on processor 2502. Also as is well known in the art, primary storage typically includes basic operating instructions, program code, data and objects used by the processor 2502 to perform its functions (e.g., programmed instructions). For example, memory 2510 can include any suitable computer-readable storage media, described below, depending on whether, for example, data access needs to be bi-directional or uni-directional. For example, processor 2502 can also directly and very rapidly retrieve and store frequently needed data in a cache memory (not shown).

A removable mass storage device 2512 provides additional data storage capacity for the computer system 2500, and is coupled either bi-directionally (read/write) or uni-directionally (read only) to processor 2502. For example, storage 2512 can also include computer-readable media such as magnetic tape, flash memory, PC-CARDS, portable mass storage devices, holographic storage devices, and other storage devices. A fixed mass storage 2520 can also, for example, provide additional data storage capacity. The most common example of mass storage 2520 is a hard disk drive. Mass storages 2512, 2520 generally store additional programming instructions, data, and the like that typically are not in active use by the processor 2502. It will be appreciated that the information retained within mass storages 2512 and 2520 can be incorporated, if needed, in standard fashion as part of memory 2510 (e.g., RAM) as virtual memory.

In addition to providing processor 2502 access to storage subsystems, bus 2514 can also be used to provide access to other subsystems and devices. As shown, these can include a display monitor 2518, a network interface 2516, a keyboard 2504, and a pointing device 2506, as well as an auxiliary input/output device interface, a sound card, speakers, and other subsystems as needed. For example, the pointing device 2506 can be a mouse, stylus, track ball, or tablet, and is useful for interacting with a graphical user interface.

The network interface 2516 allows processor 2502 to be coupled to another computer, computer network, or telecommunications network using a network connection as shown. For example, through the network interface 2516, the processor 2502 can receive information (e.g., data objects or program instructions) from another network or output information to another network in the course of performing method/process steps. Information, often represented as a sequence of instructions to be executed on a processor, can be received from and outputted to another network. An interface card or similar device and appropriate software implemented by (e.g., executed/performed on) processor 2502 can be used to connect the computer system 2500 to an external network and transfer data according to standard protocols. For example, various process embodiments disclosed herein can be executed on processor 2502, or can be performed across a network such as the Internet, intranet networks, or local area networks, in conjunction with a remote processor that shares a portion of the processing. Additional mass storage devices (not shown) can also be connected to processor 2502 through network interface 2516.

An auxiliary I/O device interface (not shown) can be used in conjunction with computer system 2500. The auxiliary I/O device interface can include general and customized interfaces that allow the processor 2502 to send and, more typically, receive data from other devices such as microphones, touch-sensitive displays, transducer card readers, tape readers, voice or handwriting recognizers, biometrics readers, cameras, portable mass storage devices, and other computers.

In addition, various embodiments disclosed herein further relate to computer storage products with a computer readable medium that includes program code for performing various computer-implemented operations. The computer-readable medium is any data storage device that can store data which can thereafter be read by a computer system. Examples of computer-readable media include, but are not limited to, all the media mentioned above: magnetic media such as hard disks, floppy disks, and magnetic tape; optical media such as CD-ROM disks; magneto-optical media such as optical disks; and specially configured hardware devices such as application-specific integrated circuits (ASICs), programmable logic devices (PLDs), and ROM and RAM devices. Examples of program code include both machine code, as produced, for example, by a compiler, or files containing higher level code (e.g., script) that can be executed using an interpreter.

The computer system shown in FIG. 25 is but an example of a computer system suitable for use with the various embodiments disclosed herein. Other computer systems suitable for such use can include additional or fewer subsystems. In addition, bus 2514 is illustrative of any interconnection scheme serving to link the subsystems. Other computer architectures having different configurations of subsystems can also be utilized.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method, comprising:
providing a user interface for managing an investigation of an incident, wherein the user interface includes content that is based on a role type of a user associated with the investigation;
receiving information regarding the incident via the user interface;
determining a suggested action based on the information to address the incident; and
updating the user interface to indicate the suggested action.

2. The method of claim 1, further comprising:
determining, via a trained machine learning model, the suggested action to address the incident, wherein the trained machine learning model is trained based on past actions to address incidents that are similar to the incident.

3. The method of claim 1, further comprising:
providing the user interface to at least one user with a role type as a safety investigation team member;
providing the user interface to at least one user with a role type as a witness of the incident; and
providing the user interface to at least one user with a role type as a collaborator.

4. The method of claim 3, further comprising:
providing the user interface to the at least one user with the role type as the safety investigation team member for conducting the investigation of the incident;
providing the user interface to the at least one user with the role type as the witness of the incident for providing the information regarding the incident; and
providing the user interface to the at least one user with the role type as the collaborator for receiving the suggested action to address the incident.

5. The method of claim 4, wherein the conducting the investigation of the incident comprises:
assigning, via the user interface, by the at least one user with the role type as the safety investigation team member, a task to another user to provide or analyze the information regarding the incident; and
monitoring, via the user interface, a status of the assigned task.

6. The method of claim 4, wherein the conducting the investigation of the incident comprises:
assigning, via the user interface, by the at least one user with the role type as the safety investigation team member, the suggested action to another user, wherein the suggested action comprises a corrective action or a preventative action corresponding to the incident; and
monitoring, via the user interface, a status of the assigned action.

7. The method of claim 4, wherein the conducting the investigation of the incident comprises:
conducting, via the user interface, by the at least one user with the role type as the safety investigation team member, a root cause analysis; and
determining a second suggested action to address the incident based on a result of the root cause analysis.

8. The method of claim 7, wherein the root cause analysis comprises a five whys root cause analysis.

9. The method of claim 4, further comprising:
determining, via a trained machine learning model, a suggested next step for conducting the investigation of the incident via the user interface, wherein the trained machine learning model is trained based on past steps for conducting past investigations of incidents that are similar to the incident; and
updating the user interface to indicate the suggested next step.

10. The method of claim 4, further comprising:
determining, via a trained machine learning model, a suggested new user to be added as a user with a role type as a collaborator, wherein the trained machine learning model is trained based on past users involved in past investigations of past incidents that are similar to the incident; and
updating the user interface to indicate the suggested new user.

11. The method of claim 1, wherein the suggested action is a part of a defined workflow, wherein a workflow defines one or more actions in a predetermined order and one or more users associated with the one or more actions.

12. A system, comprising:
a processor configured to:
provide a user interface for managing an investigation of an incident, wherein the user interface includes content that is based on a role type of a user associated with the investigation;
receive information regarding the incident via the user interface;
determine a suggested action based on the information to address the incident; and
update the user interface to indicate the suggested action; and
a memory coupled to the processor and configured to provide the processor with instructions.

13. The system of claim 12, wherein the processor is configured to:
determine, via a trained machine learning model, the suggested action to address the incident, wherein the trained machine learning model is trained based on past actions to address incidents that are similar to the incident.

14. The system of claim 13, wherein the processor is configured to:
provide the user interface to at least one user with a role type as a safety investigation team member for conducting the investigation of the incident;
provide the user interface to at least one user with a role type as a witness of the incident for providing the information regarding the incident; and
provide the user interface to at least one user with a role type as a collaborator for receiving the suggested action to address the incident.

15. The system of claim 14, wherein the conducting the investigation of the incident comprises:
assigning, via the user interface, by the at least one user with the role type as the safety investigation team member, a task to another user to provide or analyze the information regarding the incident; and
monitoring, via the user interface, a status of the assigned task.

16. The system of claim 14, wherein the conducting the investigation of the incident comprises:
assigning, via the user interface, by the at least one user with the role type as the safety investigation team member, the suggested action to another user, wherein the suggested action comprises a corrective action or a preventative action corresponding to the incident; and
monitoring, via the user interface, a status of the assigned action.

17. The system of claim 14, wherein the conducting the investigation of the incident comprises:
conducting, via the user interface, by the at least one user with the role type as the safety investigation team member a root cause analysis; and
determining a second suggested action to address the incident based on a result of the root cause analysis.

18. The system of claim 14, wherein the processor is configured to:
determine, via a trained machine learning model, a suggested next step for conducting the investigation of the incident via the user interface, wherein the trained machine learning model is trained based on past steps for conducting past investigations of incidents that are similar to the incident; and
update the user interface to indicate the suggested next step.

19. The system of claim 14, wherein the processor is configured to:
determine, via a trained machine learning model, a suggested new user to be added as a user with a role type as a collaborator, wherein the trained machine learning model is trained based on past users involved in past investigations of past incidents that are similar to the incident; and
update the user interface to indicate the suggested new user.

20. A computer program product embodied in a non-transitory computer readable medium and comprising computer instructions for:
providing a user interface for managing an investigation of an incident, wherein the user interface includes content that is based on a role type of a user associated with the investigation;
receiving information regarding the incident via the user interface;
determining a suggested action based on the information to address the incident; and
updating the user interface to indicate the suggested action.
